(19) United States
(12) Patent Application Publication
(10) Pub. No.: US 2016/0180491 A1
(43) Pub. Date: Jun. 23, 2016

(54) DISPLAY SYSTEM HAVING TWO SYSTEMS WHICH OPERATE ONE AT A TIME

(71) Applicant: BENQ CORPORATION, Taipei (TW)

(72) Inventor: Hsin-Nan Lin, Taipei (TW)

(21) Appl. No.: 14/972,002

(22) Filed: Dec. 16, 2015

(30) Foreign Application Priority Data
Dec. 18, 2014 (TW) 103144370

(51) Int. Cl. G06T 1/20; G06T 1/60; G09G 5/36

(52) U.S. Cl. CPC G06T 1/20; G09G 5/363; G06T 1/60; G09G 2360/06

(57) ABSTRACT

A display system has a first system and a second system. The first system generates a first notification signal to a graphic card when the first system is selected to process an image. A second memory module of the second system is disabled by controlling the second system. When the graphic card receives the first notification signal, the graphic card reads first display data from the first memory module. The graphic card displays the image on a display device according to the first display data of the first memory module.

### CROSS REFERENCE TO RELATED APPLICATION

This non-provisional application claims priority of Taiwan application 103144370, filed on Dec. 18, 2014, and included herein by reference.

### BACKGROUND OF THE INVENTION

1. Field of the Invention

The present invention presents a display system, and more particularly, a display system having two systems that operate one at a time to prevent malfunction from occurring when the two systems output identical data.

2. Description of the Prior Art

With the advancements to the display monitors being developed at present, display monitors having various functions and resolutions are starting to appear. At present, to satisfy the trends for high end graphics and for powerful independent graphic card to gradually replace integrated graphic card, the monitor may use the independent graphic card to output various high definition video signals, for example, signals used by high definition multimedia interface (HDMI), digital visual interface (DVI), or display port (DP). In order to further increase the quality of the display image, many high end graphic cards may use special techniques to boost its performance during image processing. For example, GeForce™ graphic cards have developed a technique for synchronous driving called G-Sync to improve the vertical sync pulse, to decrease the time delay for image processing, and to optimize the refresh rate and floating point operation during display of image. In this way, the user may be able to have a high quality visual experience. Therefore, monitors are gradually being developed to have dual system using different computing chips to perform image processing, i.e. scalar integrated circuit (IC), central processing unit (CPU), or microcontroller (MCU). A monitor having a system with multiple processing cores in combination with high quality image processing function of the graphic card may allow the graphic card to have the optimal display performance.

However, for a monitor having two systems, if the two systems output similar resolution (i.e. 1920×1080), because the graphic card simultaneously retrieves the extended display identification data (EDID) of the two systems, the graphic card may retrieve the same signal for the two systems. Malfunctions, such as having interference lines when displaying the generated image, may occur when switching between the two systems.

### SUMMARY OF THE INVENTION

An embodiment presents a method of operating a display system. The display system includes a first system and a second system. The method includes the first system generating a first notification signal to a graphic card when the first system is selected to process an image, controlling the second system to disable a second memory module of the second system, the graphic card reading first display data from a first memory module when the graphic card receives the first notification signal, and the graphic card displaying the image on a display device according to the first display data from the first memory module.

Another embodiment presents a display system. The display system includes a graphic card and a monitor coupled to the graphic card. The graphic card includes a first system used to process display data, a second system used to process display data, and a display device coupled to the first system and the second system and used to display an image. The first system includes a first memory module used to store first display data. The second system includes a second memory module used to store second display data. When the first system is selected to process the image, the first system generates a first notification signal to a graphic card. The monitor controls the second system to disable the second memory module of the second system. When the graphic card receives the first notification signal, the graphic card reads the first display data from a first memory module. The graphic card displays the image on the display device according to the first display data from the first memory module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a display system according to an embodiment of the present invention.

FIG. 2 illustrates a circuit diagram of the first drive signal control module in FIG. 1.

FIG. 3 illustrates a circuit diagram of the first hot-plugin control module in FIG. 1.

FIG. 4 illustrates a circuit diagram of the first memory module in FIG. 1.

### DETAILED DESCRIPTION

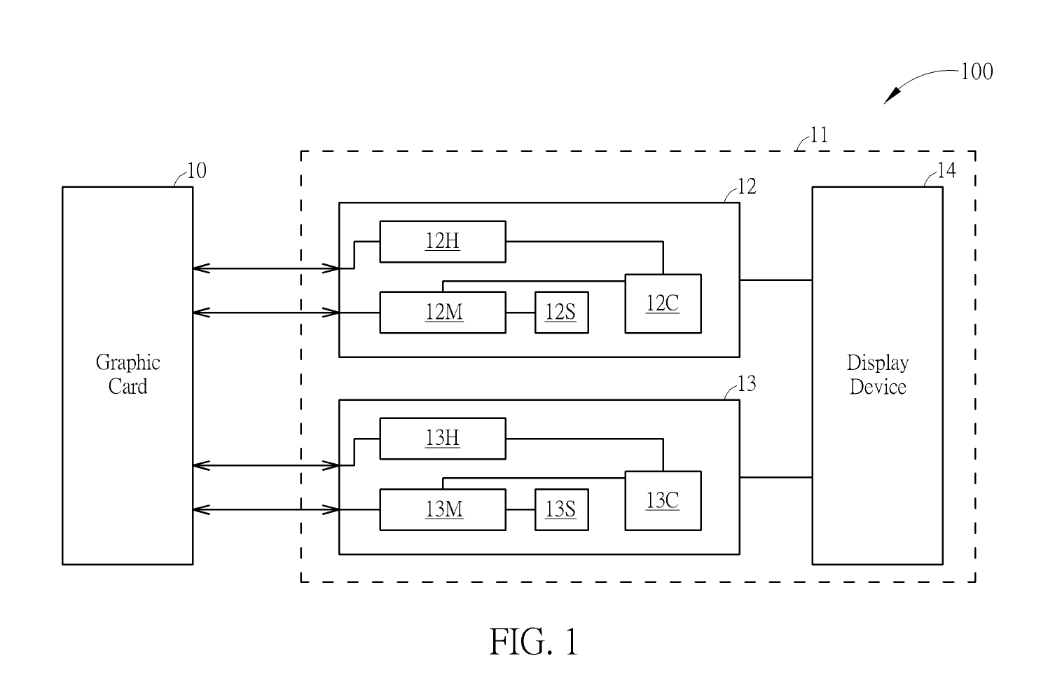

FIG. 1 illustrates a block diagram of a display system 100 according to an embodiment of the present invention. As shown in FIG. 1, the display system 100 comprises a graphic card 10 and a monitor 11. The graphic card 10 may be any type of graphic card. For example, the graphic card 10 may be an independent graphic card externally coupled to the motherboard, a built-in graphic card, a graphic chip, etc. The monitor 11 may have any two types of systems for implementing display functions. For example, the systems may include a scalar integrated circuit system for signals corresponding to high definition multimedia interface (HDMI) and high definition multimedia interface (DVI) and a G-sync system for signals corresponding to display port (DP). The monitor 11 is not limited to having abovementioned systems. For the embodiment, the monitor 11 may comprise a first system 12, a second system 13, and a display device 14. The display device 14 may be any type of display screen or projection screen. The first system 12 may comprise a first drive signal control module 12C, a first hot-plugin control module 12H, a first memory module 12M, and a first switch 12S. The first drive signal control module 12C may be coupled to the first hot-plugin control module 12H and the first memory module 12M. The second system 13 may comprise a second drive signal control module 13C, a second hot-plugin control module 13H, a second memory module 13M, and a second switch 13S. The second drive signal control module 13C may be coupled to the second hot-plugin control module 13H and the second memory module 13M. The first memory module 12M and the second memory module 13M may be an electrically erasable programmable read only memory (EEPROM) or a programmable read-only memory (PROM). The first memory module 12M may be used by the first system 12 to store extended display identification data (EDID). The second memory module 13M may be used by the second system 13 to store extended display identification data (EDID). The EDID may have data including screen resolution, image resolution, color adjustment, clock synchronization, etc. For a conventional display system, if the monitor has two systems, the graphic card simultaneously retrieves the EDID of the memory modules of the two systems. Therefore, when the two systems use the same resolution, two identical sets of EDID are retrieved from the two systems simultaneously and cause a malfunction when switching between the two systems. Thus, the display system 100 of the present invention may disable the memory module of another system when a system is being used. In this way, the graphic card 10 will only retrieve one set of EDID and avoid interference when switching between the two systems. The following is a detailed description of how to avoid malfunction in the display while operating the two systems of the display system 100.

A method of operating the display system 100 according to an embodiment is described in the following paragraph. For example, the first system 12 may be the master and the second system 13 may be the slave. The user may select a system using any method. For example, software or on screen display (OSD) of the monitor 11 may be used to control the graphic card 10 and operate the display system 100 to select the first system. When the user selects the first system 12 to process an image, the display device 14 may generate a driving signal SS having a high voltage level for the first drive signal control module 12C of the first system 12. After the first drive signal control module 12C receives the drive signal SS, the first drive signal control module 12C may generate control signals each having a high voltage level. A portion of control signals may be transmitted to the first memory module 12M. Another portion of the control signals may be transmitted to the first hot-plugin control module 12H. After the first hot-plugin control module 12H receives the control signals, a first notification signal HS may be generated and the first notification signal HS may be a signal having a voltage level that changes in time. However, for consistency, the first notification signal HS may also be referred to as a hot-plugin signal HS. At least one of the plurality of control signals may turn on a switch 12S coupled to the first memory module 12M to enable the first memory module 12M. The abovementioned hot-plugin signal HS generated by the first hot-plugin control module 12H may be received by the graphic card 10. The hot-plugin signal HS generated by the first hot-plugin control module 12H may be a signal having a voltage level changing in time. Therefore, the graphic card 10 may be triggered to read the EDID of the first memory module 12M. In this time, because the first memory module 12M has been enabled, the first memory module 12M may transmit an image data signal DS having EDID to the graphic card 10. The display system 100 may generate a drive signal SS having a low voltage level for the second drive signal control module 13C of the second system 13. Under this condition, the second drive signal control module 13C may transmit control signals having low voltage levels. Therefore, the second hot-plugin control module 13H coupled to the second drive signal control module 13C may transmit a hot-plugin signal HS having a low voltage level that is not time variant. The corresponding switch 13S of the second memory module 13H coupled to the second drive signal control module 13C may not be enabled and the second memory module 13M may stay disabled. Furthermore, when the hot-plugin signal HS having a low voltage level that is not time variant corresponding to the second system 13 is received by the graphic card 10, the graphic card 10 may not be triggered to read the EDID corresponding to the second memory module 13M. Since the second memory module 13M has not been enabled, the image data signal having the EDID corresponding to the second memory module 13M may not be transmitted to the graphic card 10.

In the display system 100, if the user chooses the first system 12 to display an image, the graphic card 10 may only read the EDID in the first memory module 12M of the first system 12 and the display device 14 may display an image according to the EDID of the first system 12. The graphic card 10 may not read the EDID of the second memory module 13M of the second system 13. In an embodiment, the graphic card 10 may only read the EDID of one system at a time. Therefore, the display system is able to avoid malfunction caused by reading two sets of EDID at the same time. In the same way, if the user selects the second system 13 to display an image, the display system 100 may control the first system 12 to disable the first memory module 12M of the first system 12 and the second memory module 13M of the second system 13 may be enabled. The display system 100 may transmit a hot-plugin signal HS having an increasing voltage level corresponding to the second system 13 to the graphic card 10 and trigger the graphic card 10 to read the EDID in the second memory module 13M. The display device 14 may then display the image according to the EDID of the second system 13. The step for disabling the first memory module 12M and enabling the second memory module 13M may be the same as the abovementioned method where the first memory module 12M is enabled and the second memory module 13M is disabled when the first system has been selected to display an image. Thus, the detailed description of the method for using the second system 13 to display an image will no longer be included for brevity. The following paragraph will give a detailed description of the circuit diagram of the first drive signal control module 12C, the first hot-plugin control module 12H, and the first memory module 12M of the first system 12.

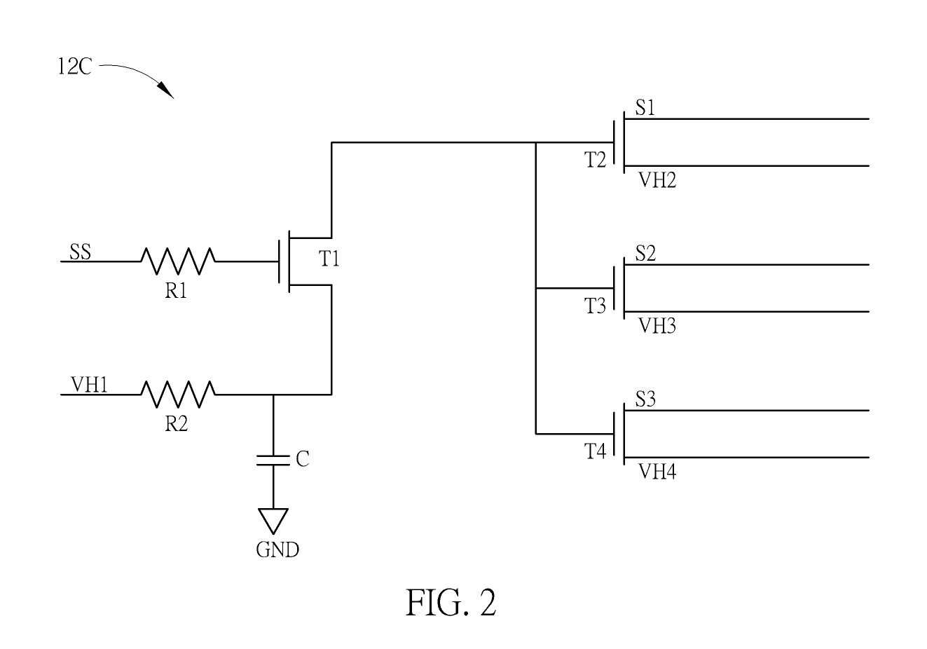

FIG. 2 illustrates a circuit diagram of the first drive signal control module 12C in FIG. 1. As shown in FIG. 2, the first drive signal control module 12C comprises two resistors R1 and R2, four transistors T1 to T4, and a capacitor C. The drive signal SS may be the input signal of the first drive signal control module 12C. The control signals S1 to S3 may be the output signals of the first drive signal control module 12C. A high voltage level signal VH1 may be a +5V voltage signal. High voltage level signals VH2 to VH4 may be +5V voltage signals supplied by the computer. And, GND may be the ground terminal. If the user selects the first system 12 to display an image, the display system 100 may generate a driving signal SS having a high voltage level to input to the first drive signal control module 12C of the first system 12. In this time, the gate electrode of the transistor T1 receives driving signal SS and the transistor T1 may then be turned on. The capacitor C may not be charged initially. The high voltage signal VH1 may be transmitted to the gate electrode of the transistors T2 to T4 through the transistor T1. When the gate electrodes of the transistors T2 to T4 receive the high voltage signal VH1, the transistors T2 to T4 may be enabled. In this time, if the initial state of the control signals S1 to S3 is a low voltage level, then the high voltage signal VH2 may flow through the transistor T2 to increase the control signal S1 to a high voltage level, the high voltage signal VH3 may flow through the transistor T3 to increase the control signal S2 to a high voltage level, and the high voltage signal VH4 may flow through the transistor T4 to increase the control signal S3 to a high voltage level. Therefore, when the driving signal SS transmitted to the first drive signal control module 12C is a high voltage level, the control signals S1 to S3 outputted may each be increased to be high voltage levels. On the other hand, if the first system 12 is not selected to display the image, the driving signal SS inputted to the first drive signal control module 12C may be a low voltage level. Under this condition, the gate electrodes of the transistors T2 to T4 may not receive the high voltage signal VH1 and stay at initial conditions which may be a low voltage level. The transistors T1 to T4 may not be enabled and the control signals S1 to S3 outputted may stay at initial conditions which may be low level voltages.

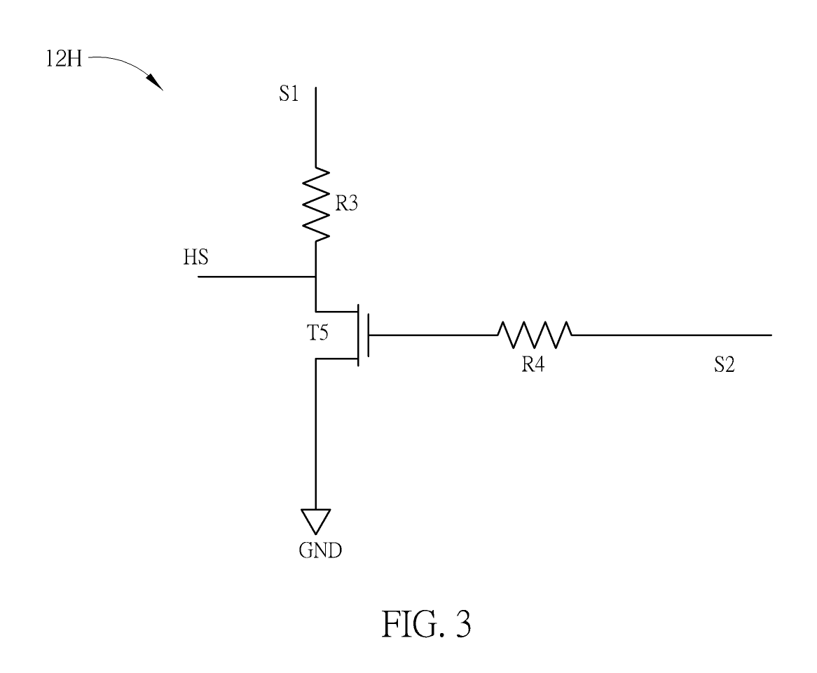

FIG. 3 illustrates a circuit diagram of the first hot-plugin control module 12H in FIG. 1. As shown in FIG. 3, the first hot-plugin control module 12H comprises two resistors R3 and R4, and a transistor T5. The control signals S1 and S2 outputted by the first drive signal control module 12C may be the input signals of the hot-plugin control module 12H. The hot-plugin signal HS may be the output signal of the hot-plugin control module 12H. And, GND may be the ground terminal. If the user selects the first system 12 to display an image, the display device 14 may generate a driving signal SS having a high voltage level for the first drive signal control module 12C of the first system 12 and the first drive signal control module 12C may generate three control signals S1 to S3 each having a high voltage level. In this time, the hot-plugin signal HS may temporarily have a high voltage level inputted from the control signal S1 having a high voltage level. Meanwhile the voltage inputted to the gate electrode of the transistor T5 of the hot-plugin control module 12H may be the control signal S2 having a high voltage level. There may be a delay to the enabling of the transistor T5 after the gate electrode of the transistor T5 receives the control signal S2. After the transistor T5 is enabled, the control signal S1 may pass through the transistor T5 and to the ground GND. While the transistor T5 is enabled, the hot-plugin signal HS may be pulled to the ground terminal GND. The voltage level of the hot-plugin signal HS may be time variant. The voltage level of the hot-plugin signal HS may initially be at low voltage level then change to high voltage level upon receiving a control signal S1 having a high voltage level and then change back to a low voltage level upon enabling of the transistor T5. In this way, the hot-plugin signal HS may be a pulse signal. On the other hand, if the first system 12 is not selected to display the image, the driving signal SS inputted to the first drive signal control module 12C may be a low voltage level. Under this condition, the gate electrodes of the transistors T2 to T4 may not receive the high voltage signal VH1 and stay at initial conditions which may be a low voltage level. The transistors T1 to T4 may not be enabled and the control signals S1 to S3 outputted may stay at initial conditions which may be low level voltages. The control signal S2 received by the gate electrode of the transistor T5 of the hot-plugin control module 12H may be a low voltage level and the transistor T5 may not be enabled. The control signal S1 having a low voltage level may, in turn, cause the hot-plugin signal HS to output a low voltage level that is not time variant.

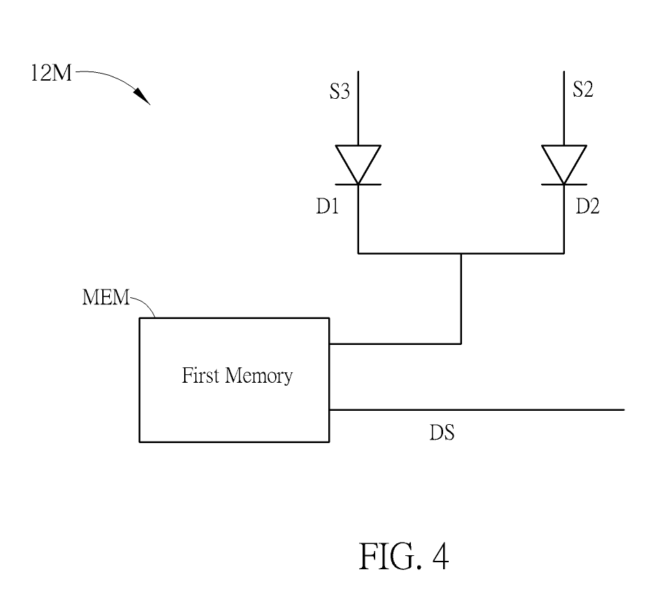

FIG. 4 illustrates a circuit diagram of the first memory module 12M in FIG. 1. As shown in FIG. 4, the first memory module 12M may comprise two diodes D1 and D2 and a first memory MEM. If the user selects the first system 12 to display an image, the display device 14 may generate a driving signal SS having a high voltage level for the first drive signal control module 12C of the first system 12 and the first drive signal control module 12C may generate three control signals S1 to S3 each having a high voltage level. Also, the hot-plugin control module 12H may generate a hot-plugin signal HS having a voltage level that may be time variant such as a pulse. In the first memory module 12M, the control signals S2 and S3 having high voltage levels may respectively go through the input of the diodes D2 and D1 and then into the first memory MEM. In response to the high voltage levels of the control signals S2 and S3, the switch 12S in FIG. 1 is turned on. After the switch 12S is turned on, the first memory MEM may be enabled because in order to enable the first memory MEM, the switch 12S has to be turned on and the high voltage levels of the control signals S2 and S3 have to be inputted to the first memory MEM. In this time, when the graphic card 10 receives the hot-plugin signal HS, the graphic card 10 may read the EDID in the first memory MEM. Therefore, the first memory MEM may transmit the display data signal DS having EDID to the graphic card 10. More specifically, the display data signal DS transmitted by the first memory MEM may comprise serial data lines (SDA) and serial clock lines (SCL) having resolution information for the display device. After graphic card 10 has extracted the EDID of the first memory MEM from the display data signal DS, the graphic card 10 may use the EDID to display the image on the display device 14. On the other hand, if the first system 12 is not selected to display the image, the driving signal SS inputted to the first drive signal control module 12C may be a low voltage level. Under this condition, the control signals S2 and S3 are low voltage levels, the first memory MEM may not be enabled. In this condition, the first MEM may not be able to transmit the display data signal DS having EDID to the graphic card 10.

As shown in FIG. 2 to FIG. 4, the display system 100 may use the first drive signal control module 12C, the first hot-plugin control module 12H, and the first memory module 12M for the graphic card 10 to be able to selectively read the EDID in the first system 12. In the same way, the display system 100 may use the second drive signal control module 13C, the second hot-plugin control module 13H, and the second memory module 13M for the graphic card 10 to be able to selectively read the EDID in the second system 13. Since the operation of the first system 12 and the second system 13 are similar to each other, the operation of the second system 13 when selected to display an image will no longer be described for brevity. The display system 100 may only be able to read the EDID of one system at a time.

The present invention presents a display system. The display system may have two systems. To avoid malfunctions that may occur when switching between the two systems such as having interference lines when displaying the generated image, the present invention may enable the memory module of the system selected and disable the memory module of the other system that has not been selected. The display system of the present invention may be able to avoid any interference caused by retrieving two similar EDID at the same time. Thus, the display system of the present invention may be able to improve the quality of the image outputted using display system having two systems.

Furthermore, the embodiments shown in FIGS. 1 to 4 are only exemplary embodiments and are not used to limit the scope of the invention. The method disclosed in the present invention may be used in other display systems having at least two systems. The idea of the present invention for operating a display system is to select one preferred system and disable another system. Since the selected system is operated exclusively, no interference is introduced. As a result, error on the image caused by another system may be eliminated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of operating a display system, the display system comprising a first system and a second system, the method comprising:
when the first system is selected to process an image, the first system generating a first notification signal to a graphic card;
controlling the second system to disable a second memory module of the second system;
when the graphic card receives the first notification signal, the graphic card reading first display data from a first memory module; and
the graphic card displaying the image on a display device according to the first display data from the first memory module.

2. The method of claim 1, wherein the first system comprises a first drive signal control module and a first hot-plugin control module coupled to the first drive signal control module, the method further comprises:
when the first system is selected to process the image, the first hot-plugin control module transmitting the first notification signal to the graphic card; and
turning on a switch coupled to the first memory module to enable the first memory module.

3. The method of claim 2, wherein the first notification signal is a signal having a time variant voltage level.

4. The method of claim 1, wherein controlling the second system to disable the second memory module of the second system is turning off a switch coupled to the second memory module to disable the second memory module.

5. The method of claim 4, wherein the second system comprises a second drive signal control module and a second hot-plugin control module coupled to the second drive signal control module, the method further comprising:
when the first system is selected to process the image, the second hot-plugin control module transmitting a second notification signal to the graphic card;
wherein the second notification signal is a signal having a voltage level not time variant.

6. The method of claim 1, further comprising:
when the second system is selected to process an image, the second system generating a second notification signal to a graphic card;
controlling the first system to disable the first memory module of the first system;
when the graphic card receives the second notification signal, the graphic card reading second display data from the second memory module; and
the graphic card displaying the image processed by the second system on the display device according to the second display data from the second memory module.

7. The method of claim 1, wherein the first system is a scalar integrated circuit system and the second system is a synchronous driving system.

8. A display system, comprising:
a graphic card; and
a monitor coupled to the graphic card, the monitor comprising:
a first system configured to process display data, the first system comprising:
a first memory module configured to store first display data;
a second system configured to process display data, the second system comprising:
a second memory module configured to store second display data; and
a display device coupled to the first system and the second system and configured to display an image;
wherein when the first system is selected to process the image, the first system generates a first notification signal to the graphic card; the monitor controls the second system to disable the second memory module of the second system; when the graphic card receives the first notification signal, the graphic card reads the first display data from the first memory module; and the graphic card displays the image on the display device according to the first display data from the first memory module.

9. The display system of claim 8, wherein the first display data stored in the first memory module is extended display identification data of the first system; and the second display data store in the second memory module is extended display identification data of the second system.

10. The display system of claim 8, wherein the first system is a scalar integrated circuit system.

11. The display system of claim 8, wherein the second system is a synchronous driving system.

12. The display system of claim 8, wherein the first system further comprises:
a first drive signal control module coupled to the first memory module;
a first hot-plugin control module coupled to the first drive signal control module and configured to transmit the first notification signal to the graphic card when the first system is selected to process the image; and
a switch coupled to the first memory module and configured to enable the first memory module.

13. The display system of claim 12, wherein the first notification signal transmitted by the first hot-plugin control module is a signal having a time variant voltage level when the first system is selected to process the image.

14. The display system of claim 12, wherein the first notification signal is generated in response to a delay in enabling of a transistor of the first hot-plugin control module.

15. The display system of claim 12, wherein the second system further comprises:
a switch coupled to the second memory module and configured to disable the second memory module when the first system is selected to process the image.

16. The display system of claim 8, wherein the second system further comprises:
a second drive signal control module coupled to the second memory module;
a second hot-plugin control module coupled to the second drive signal control module and configured to transmit a second notification signal to the graphic card when the first system is selected to process the image; and
a switch coupled to the second memory module and configured to enable the second memory module when the second system is selected to process the image.

17. The display system of claim 16, wherein the second notification signal transmitted by the second hot-plugin control module is a signal having a time variant voltage level.

18. The display system of claim 16, wherein the second notification signal is generated in response to a delay in enabling of a transistor of the second hot-plugin control module.

19. The display system of claim 16, wherein the first system further comprises a switch coupled to the first memory module and configured to disable the first memory module when the second system is selected to process the image.

20. The display system of claim 16, wherein the graphic card is configured to read the second display data from the second memory module when the graphic card receives the second notification signal and displays the image processed by the second system on the display device according to the second display data from the second memory module.
